(19) United States
(12) Patent Application Publication
(10) Pub. No.: US 2011/0279034 A1
(43) Pub. Date: Nov. 17, 2011

(54) LIGHT FIXTURE WITH FLAMELESS CANDLE

(76) Inventors: Scott Lucas, Newport Beach, CA (US); Jeff Thompson, Newport Beach, CA (US); Peter Smith, Newport Beach, CA (US); Bob Gast, Foothill Ranch, CA (US); Allen Young, Foothill Ranch, CA (US); Caroline Gray, Foothill Ranch, CA (US); Alex McKinnon, Foothill Ranch, CA (US)

(21) Appl. No.: 13/087,080

(22) Filed: Apr. 14, 2011

Related U.S. Application Data
(60) Provisional application No. 61/324,266, filed on Apr. 14, 2010.

(51) Int. Cl. H05B 37/02; F21V 21/00

(52) U.S. Cl. 315/92; 362/249.01; 362/249.02

(57) ABSTRACT

Light fixtures are disclosed having a first light source. The light fixtures can include a second light source, and a flameless candle that includes the first light source. A sensor can also be included that is configured to detect at least one of movement and light, and produces a sensor signal.

This application claims the benefit of priority to U.S. provisional application having Ser. No. 61/324,266 filed on Apr. 14, 2010. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is light fixtures.

### BACKGROUND

Various systems and methods are known in the art to create a flickering flame effect. See, for example, U.S. Pat. No. 7,159,994 to Schnuckle et al. and U.S. Pat. No. 7,261,455 to Schnuckle et al. Although the Schnuckle devices can be useful for novelty purposes, they are impractical where greater amounts of light are needed, especially in outdoor locations.

U.S. Pat. No. 7,377,667 to Richmond discusses a light device having a light emitting element that can be configured to emit flickering light. However, the Richmond device fails to discuss having a brighter, secondary light source in addition to the low-light source, as well as a motion sensor.

Thus, there is still a need for light fixtures having a flameless candle with a first light source, and a brighter, secondary light source.

### SUMMARY OF THE INVENTION

The inventive subject matter provides apparatus, systems and methods for a light fixture having a housing that contains a first light source. In preferred embodiments, the light fixture has a lantern-shape having at least one side wall collectively through which light can emanate over a combined arc of at least 60°, although any commercially suitable shapes are contemplated. For example, a square-shaped fixture could have four side walls, which each has a glass panel through which light can emanate.

The light fixture can have a flameless candle that includes the first light source. In this manner, the light fixture can appear to have a burning candle without the associated dangers. As used herein, the term “flameless candle” means a light source that emulates a traditional candle flame, whether by air movement, electromagnets, flickering of the light source, or so forth. Exemplary flameless candles are discussed in U.S. Pat. Nos. 7,159,994 and 7,261,455, and U.S. patent publ. no. 2011/0019422 to Schnuckle et al. (publ. January 2011).

A second light source can also be included in the light fixture, and is preferably separate and distinct from the first light source. It is especially preferred that the second light source produces light having a brightness that is at least five times, and more preferably at least ten times the brightness of light produced by the first light source, such that the second light source can produce light that is substantially brighter than the first light source. In this manner, the first light source of the flameless candle can produce ambient light, while the second light source can at least temporarily produce brighter light for safety or other purposes, for example, which would otherwise overpower the ambient light produced by the first light source. Such difference in brightness is critical to produce the conflicting amounts of light required for these distinct purposes, and could not otherwise be accomplished. In one embodiment, the first light source could be a low-light source, while the second light source could be used to provide additional illumination when desired. For example, the first light source could be a flameless candle that emulates a flickering candle flame, and the second light source could be a series of LEDs or a halogen or compact fluorescence light bulb, for example.

The light fixture can advantageously include one or more sensors that can communicate with a controller to control one or more light sources of the fixture. Contemplated sensors include, for example, motion sensors, light sensors, and any other commercially suitable sensor. In this manner, a motion sensor could be used such that the second light source is illuminated when motion is detected.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a perspective view of one embodiment of a lantern-shape light fixture.

FIG. 2 is a bottom view of the light fixture of FIG. 1.

FIG. 3 is a perspective view of another embodiment of a light fixture.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

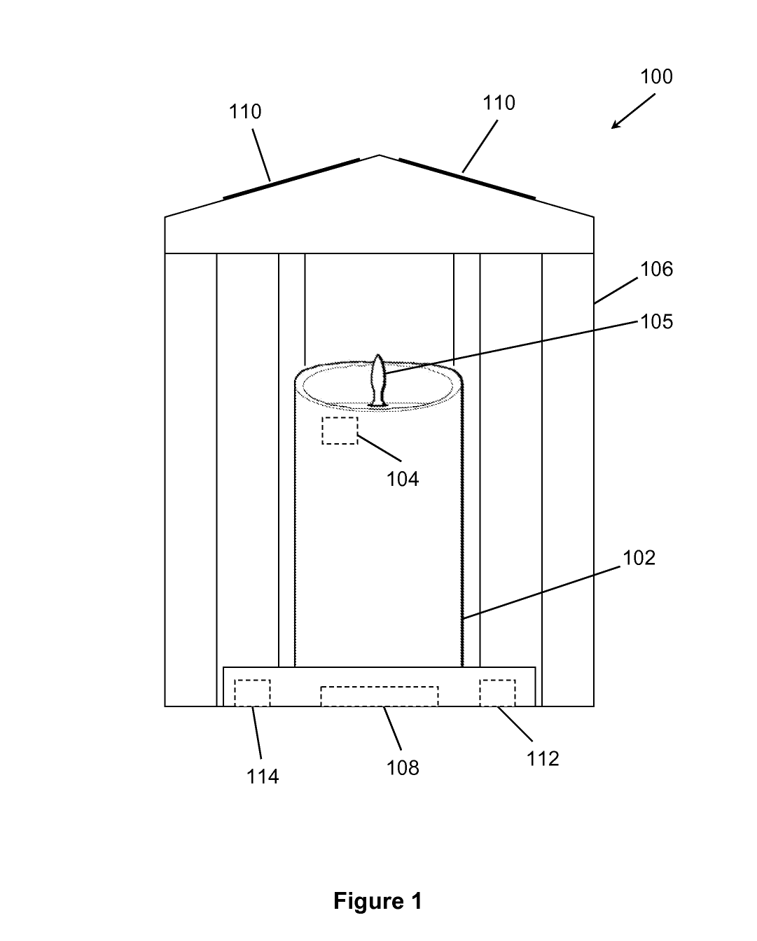

In FIG. 1, a light fixture 100 is shown that includes a flameless candle 102 having a light source 104. Exemplary flameless candles are discussed in U.S. Pat. Nos. 7,159,994 and 7,261,455, and U.S. patent publ. no. 2011/0019422 to Schnuckle et al. (publ. January 2011), although any commercially suitable flameless candle could be used that produce a flickering flame effect. Preferred flameless candles include one or more LEDs with a teardrop or flame-shaped element 105 on an upper portion of the flameless candle 102 to simulate a flickering flame.

The fixture 100 preferably comprises a lantern-shape housing 106, although it is alternatively contemplated that the housing 106 could comprise any commercially suitable shape depending upon the environment where the fixture 100 will be used. The specific size and dimension of the housing 106 could vary depending upon the size of the flameless candle 102 and the number of other components that will be included with the fixture 100. It is preferred that the fixture 100 is sized such that the fixture 100 could be hung from a post or other means.

The first light source 104 preferably comprises a LED or other low-voltage light source that is configured to generate a generally lower lumen light output. It is contemplated that the light source 104 could generate light having a brightness of at least 1 lumen, and preferably less than 50 lumens, more preferably, less than 30 lumens, and most preferably, less than 10 lumens. Although one or more LEDs are preferred, the first light source 104 could include any commercially suitable light source including, for example, those discussed above.

The light fixture 100 can also include a second light source 108, apart from the flameless candle 102, which could include one or more LEDs, a CFL bulb, a halogen lamp, or other commercially suitable light sources. Preferably, the second light source 108 generates a brighter light than that produced by the flameless candle 102, and more preferably a brightness of at least five times, ten times, or more, of the brightness of the first light source 104. This advantageously allows the light fixture 100 to be illuminated independently from the flameless candle 102, and thereby provide a brighter light source necessary for safety and other purposes. Of course, additional light sources could also be included depending on the light sources chosen, and the brightness of light and look desired. Additional LEDs can be embedded in the lower part of the flameless candle shaft that illuminate the candle body itself. The second light source 108 could be disposed within the flameless candle 102, or externally to the flameless candle 102 and/or the housing 106.

It is further contemplated that the second light source 108 could be configured to allow for various amounts of light to be emitted, such as via a dimmer switch or other means. In this manner, the light produced by the second light source 108 could be varied as needed.

In preferred embodiments, the light fixture 100 is configured for use outdoors, although it is contemplated that the light fixture 100 could be used indoor as well.

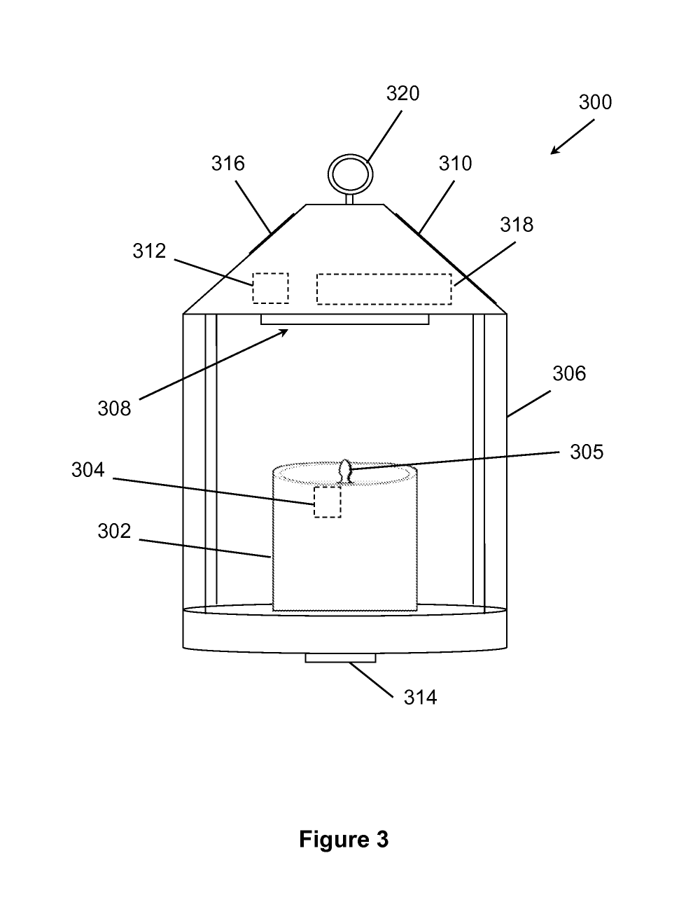

The light fixture 100 could receive power from an external source such as a line voltage. Additionally or alternatively, the light fixture 100 could have an internal power source such as a battery or could also include one or more photovoltaic cells 110. The one or more photovoltaic cells 110 could be electrically coupled to a battery (shown in FIG. 3) to allow excess energy to be stored for later use (e.g., at night or during cloudy weather). This is especially useful if the light fixture 100 will be placed outdoors, as the photovoltaic cells 110 can produce energy from the sunlight.

The light fixture 100 can include at least one sensor 114 that could be used, for example, to detect the presence of light or motion. It is contemplated that the sensor 114 could be disposed externally from the first light source 104 and controller 112, and be functionally coupled thereto via a wired or wireless connection. The use of a sensor 114 is advantageous as it allows for the detection of motion or light such that at least one of the first and second light sources 104 and 108 can be illuminated or extinguished. In preferred embodiments, the sensor 114 could comprise a dusk-to-dawn photocell sensor such that the sensor 114 could signal to controller 112 to illuminate the flameless candle 102 when the atmospheric light falls below a defined level. However, it is alternatively contemplated that the flameless candle 102 could remain activated or not independent of inputs from the dusk-to-dawn photocell or sensor, motion or other sensor, timer, controller or any combination(s) thereof.

In other contemplated embodiments, the sensor 114 could include a motion sensor, such that one or both of the first and second light sources 104 and 108 could be illuminated when motion is detected. It is contemplated that the light fixture 100 could include a timer circuitry, such that one or both of the first and second light sources 104 and 108 remains illuminated for a defined period after motion is no longer detected.

Preferably, the sensor 114 can be coupled to at least the second control system such that the second light source 108 is illuminated when motion is detected. Thus, the light fixture 100 could be configured such that the flameless candle 102 is illuminated from dusk until dawn, with the second light source 108 shut off unless motion is detected. It is contemplated that the light fixture 100 could include timer circuitry, such that the second light source 108 can be automatically extinguished after a predetermined time period.

In some contemplated embodiments, the light fixture 100 can include at least one controller 112 configured to control illumination of at least one, and preferably both, of the first and second light sources 104 and 108. Preferably, the controller 112 receives a sensor signal from sensor 114, and causes the second light source 108 to illuminate. For example, the sensor 114 could comprise a motion sensor configured to produce a sensor signal when movement is detected. The controller 112 could receive the sensor signal and cause the brighter second light source 108 to be illuminated to thereby assist a person to see a path in the evening, for example. Thus, in this manner, the light fixture 100 could utilize the first light source 104 at night to create a desired ambiance, but illuminate the second light source 108 when movement is detected to ensure a path is sufficiently lit as a user walks by, for example. Alternatively, it is contemplated that the light fixture 100 could include first and second controllers, which control the first light source 104 and the second light source 108, respectively. Thus, for example, the first controller can be configured to illuminate the flameless candle 102 all the time, or for a set duration (e.g., from dusk until dawn), and the second controller can be configured to illuminate the second light source 108 separately from the flameless candle 102.

One or more of the flameless candle 102 and the second light source 108 can be activated by the sensor 114, timer circuitry, a controller whether or not remote, or other means. To increase energy efficiency of the light fixture 100, both the first and second light sources 104 and 108 can comprise LEDs, although any commercially suitable light source could alternatively be used.

The housing 106 of the light fixture 100 is preferably configured to receive the flameless candle 102. In some embodiments, a gap could exist between the housing 106 and the flameless candle 102 to create a chimney effect that augments light output and provides color, whereas the sides of the flameless candle 102 mounted below a light source helps to increase the light spread away from the fixture 100. It is also contemplated that the housing 106 could have a portion of which is translucent or transparent, such as a glass wall. Although preferred light fixtures 100 can be sized and dimensioned to resemble a lantern, the light fixture 100 could have any commercially suitable size and dimension, especially those that allow the fixture 100 to blend into the surrounding environment. The light fixture 100 could optionally include one or more reflectors (not shown) that can assist in spreading the light to a larger area away from the light fixture 100.

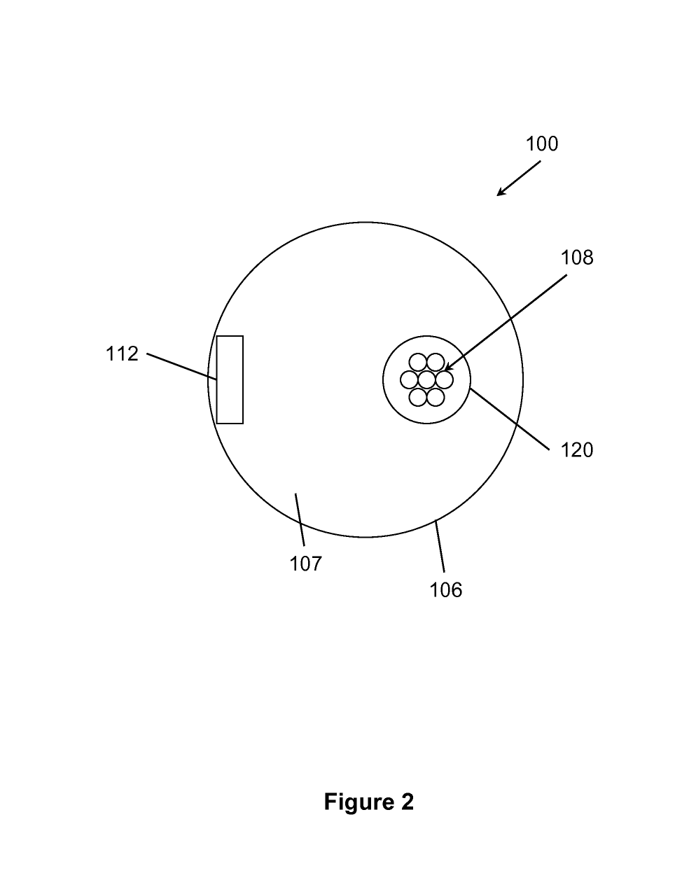

FIG. 2 illustrates a bottom view of the light fixture 100 of FIG. 1. The second light source 108 comprises a collection of LEDs, although any commercially suitable light source could be used. The second light source 108 could be disposed in a recessed portion 120 of a bottom 107 of the light fixture 100, such that the light source 108 could be hidden from normal viewing angles when in use. It is contemplated that the recessed portion 120 could be reflective and/or have a concave-shaped surface to direct light outwards from the light fixture 100.

However, it is contemplated that the second light source 108 could be disposed elsewhere about or within the light fixture 100 depending on the likely resting place for the fixture 100. Alternately, the second light source 108 could comprise a collection of LEDs disposed within and/or about the light fixture 100 such that light is produced in a variety of locations.

In FIG. 3, an alternative embodiment of a light fixture 300 is shown having first and second light sources 304 and 308. The first light source 304 can be disposed within a flameless candle 302, although it is contemplated that the first light source 304 could be disposed externally to the flameless candle 302.

The light fixture 300 can include a battery 318 that can be electrically coupled to a photovoltaic cell 310, for example, such that excess power from the cell 310 could be stored for later use. The light fixture 300 can also include a ring 320 or other mechanism such that the fixture 300 can be hung from a post or other means. In this manner, it is contemplated that a plurality of light fixtures 300 could be hung along a path, for example, or about an outdoor area, such that the area is illuminated by the “candle light”, but could have the lighting increase as needed through the use of the secondary light sources 308.

The light fixture 300 can also include a light sensor 316 configured to detect a level of light, such that one or more of the flameless candle 302 and second light source 308 can be illuminated or extinguished when the light level falls below, or increases above, one or more predetermined thresholds. With respect to the remaining numerals in FIG. 3, the same considerations for like components with like numerals of FIG. 1 apply.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A light fixture, comprising:
a housing;
a flameless candle having a first light source;
a second light source that produces light at a brightness that is at least five times a brightness of light produced by the first light source.

2. The light fixture of claim 1, wherein the housing has a lantern-shape.

3. The light fixture of claim 2, wherein the housing further comprising at least one side wall, collectively through which light can emanate over a combined arc of at least 60°.

4. The light fixture of claim 1, further comprising a motion sensor configured to detect motion and send a sensor signal to a controller.

5. The light fixture of claim 4, wherein the controller is configured to receive the sensor signal, and send a command signal to the second light source to illuminate the second light source.

6. The light fixture of claim 5, wherein the controller is further configured to send a second command signal to the first light source to shut off the first light source.

7. The light fixture of claim 4, further comprising the controller, and wherein the controller if configured to receive the sensor signal and cause the second light source to illuminate.

8. The light fixture of claim 1, wherein the flameless candle comprises an electromagnet.

9. The light fixture of claim 1, wherein the first light source comprises at least one LED.

10. The light fixture of claim 1, wherein the brightness of the first light source is no more than 10 lumens.

11. A light fixture, comprising:
a flameless candle having a first light source; and
a motion sensor.

12. The light fixture of claim 11, further comprising a controller configured to receive a sensor signal from the motion sensor, and cause the flameless candle to be shut off as a function of the sensor signal.

13. The light fixture of claim 11, further comprising a second light source having a brightness that is at least five times greater than a brightness of the first light source.

14. The light fixture of claim 11, further comprising a second light source having a brightness that is at least ten times greater than a brightness of the first light source.

15. The light fixture of claim 11, wherein the first light source emits light at a brightness of no more than 10 lumens.

16. The light fixture of claim 13, further comprising a controller configured to receive a sensor signal from the motion sensor, and cause the second light source to be illuminated as a function of the sensor signal.

17. The light fixture of claim 13, further comprising a light sensor and a controller, and wherein the controller is configured to receive a sensor signal from the light sensor and turn on the flameless candle as a function of the sensor signal.

18. The light fixture of claim 13, further comprising a photovoltaic cell electrically coupled to the flameless candle.

19. A lantern-shaped light fixture, comprising:
at least one side wall, collectively through which light can emanate over a combined arc of at least 60°;
a flameless candle having a first light source;
a second light source having a brightness that is at least five times greater than a brightness of the first light source;
a sensor configured to produce a sensor signal; and
a controller configured to receive the sensor signal, and cause at least one of the first and second light sources to illuminate.

20. The light fixture of claim 19, wherein the sensor comprises a light sensor or a motion sensor.
